(19) United States
(12) Patent Application Publication
(10) Pub. No.: US 2008/0291675 A1
(43) Pub. Date: Nov. 27, 2008

(54) LIGHT EMITTING DIODE LAMP

(75) Inventors: Shun-Tian Lin, Taipei (TW); Jyun-Wei Huang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: ADVANCED CONNECTEK INC., Taipei (TW); TYSUN INC., Taipei County (TW)

(21) Appl. No.: 12/053,619

(22) Filed: Mar. 23, 2008

(30) Foreign Application Priority Data
May 23, 2007 (TW) 96118290

(51) Int. Cl. F21V 7/00

(52) U.S. Cl. 362/247

(57) ABSTRACT

A light emitting diode (LED) lamp including a substrate, a plurality of wire units, a plurality of LED chips, a lamp cap, and a control circuit module is provided. The substrate has a carrying portion and a ring frame connected to the periphery thereof. The carrying portion has a plurality of openings. The wire units are respectively disposed inside the openings. Each wire unit has a wire and an insulating material covering the periphery of the wire, such that the wire is electrically isolated from the substrate. The LED chips are disposed on the carrying portion, and each LED chip is electrically connected to the corresponding wires. The lamp, cap is disposed on the bottom of the substrate and has two power contacts. The control circuit module is disposed between the substrate and the lamp cap and electrically connected to wires and power contacts, to control operations of LED chips.

### CROSS-REFERENCE TO RELATED APPLICATION

This application claims the priority benefit of Taiwan application serial no. 96118290, filed on May 23, 2007. The entirety the above-mentioned patent application is hereby incorporated by reference herein and made a part of specification.

### BACKGROUND OF THE INVENTION

1. Field of the Invention

The present invention generally relates to a light emitting diode (LED) lamp, in particular, to an LED lamp directly packaging LED chips on a substrate.

2. Description of Related Art

LED is a semiconductor device, and the light emitting chip is mainly made of Group III-V chemical elements, for example, GaP, GaAs, and other compound semiconductors. The light emitting principle is to convert the electric energy into lights, that is, a current is applied to the compound semiconductor, and then, through combining electrons with holes, the excess energy is released in the form of lights, so as to achieve the light emitting effect. The light emitting phenomenon of the LED is not achieved through heating or discharging, so the service life of the LED is as long as over 100 thousand hours, and no idling time is required. In addition, the LED further has the advantages of, for example, high response speed (approximately 10-9 seconds), small volume, low power consumption, low pollution, high reliability, and suitable for mass production, so the LED has a wide application field, for example, light sources and illumination devices of large-scale viewing boards, traffic lights, mobile phones, scanners, and fax machines.

The light emitting brightness and light emitting efficiency of the LED have been continuously improved, and meanwhile, the white light LED has been successfully produced through mass production, so the LED is increasingly used for illumination purpose, and the LED lamp begins to be developed.

Currently, the package design of the LED lamp is still based upon multilayer package, such that a interface thermal resistance is generated due to a plurality of package interfaces existed on the heat dissipation path, and as a result, the heat dissipation efficiency is reduced. Due to the poor heat dissipation effect, the temperature of the LED cannot be effectively reduced, which further influences the light emitting efficiency and the service life of the LED lamp.

### SUMMARY OF THE INVENTION

Accordingly, the present invention is directed to an LED lamp. The LED lamp is to directly package LED chips on a substrate with the heat dissipation function, thereby improving the heat dissipation efficiency through such a packaging manner.

The present invention provides an LED lamp, which includes a substrate, a plurality of wire units, a plurality of LED chips, a lamp cap, and a control circuit module. The substrate has an inner surface, an outer surface opposite to the inner surface, and a bottom part. The substrate has a carrying portion and a ring frame connected to a periphery of the carrying portion, and the carrying portion has a plurality of openings. The wire units are respectively disposed in the openings, and each wire unit has a wire and an insulating material covering a periphery of the wire. The LED chips are disposed on the carrying portion of the substrate, and each LED chip is electrically connected to the corresponding wires. The lamp cap is disposed on the bottom part of the substrate and has two power contacts. The control circuit module is disposed between the substrate and the lamp cap and electrically connected to the wires and the two power contacts.

According to an embodiment of the present invention, the substrate is made of a metal material. Furthermore, the metal material is select from a group consisting of copper, copper alloy, aluminum, aluminum alloy, composite material formed by copper or copper alloy, and composite material formed by aluminum or aluminum alloy.

According to an embodiment of the present invention, the substrate further includes an optical reflection film disposed on the inner surface of the substrate. Furthermore, a material of the optical reflection film is selected from a group consisting of silver, aluminum, stainless steel, and nickel.

According to an embodiment of the present invention, the insulating material is selected from a group consisting of polymer material, glass, and ceramic.

According to an embodiment of the present invention, the LED chips are electrically connected to the corresponding wires through a wire bonding technique or a flip-chip bonding technique.

According to an embodiment of the present invention, the lamp cap is a screw-in lamp cap or a bayonet lamp cap.

According to an embodiment of the present invention, the LED lamp further includes a heat sink element disposed on the outer surface of the substrate.

According to an embodiment of the present invention, the heat sink element is selected from a group consisting of a plurality of heat sink fins and a heat pipe.

According to an embodiment of the present invention, the LED lamp farther includes a molding compound, disposed within the substrate and covering the LED chips.

In the LED lamp of the present invention, the LED chips are directly packaged on the substrate with the heat dissipation function, so as to dissipate heat generated during the operation of the LED chips by the substrate made of metal material, thereby improving the heat dissipation efficiency. In addition, by means of directly packaging the LED chips on the substrate, the interface thermal resistance caused by the package interface on the heat dissipation path is effectively reduced, so as to effectively solve the current heat dissipation problem in configuring the LED lamp.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of an LED lamp according to an embodiment of the present invention.

FIG. 2 is a schematic cross-sectional view of the LED lamp shown in FIG. 1 with a bayonet lamp cap.

FIG. 3 is a schematic cross-sectional view of the LED lamp shown in FIG. 1 with an optical reflection film disposed in a substrate.

FIG. 4 is a schematic cross-sectional view of the LED lamp shown in FIG. 1 with a plurality of heat sink fins disposed on a periphery of the substrate.

FIG. 5 is a schematic cross-sectional view of the LED lamp shown in FIG. 1 with a heat pipe disposed on the periphery of the substrate.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

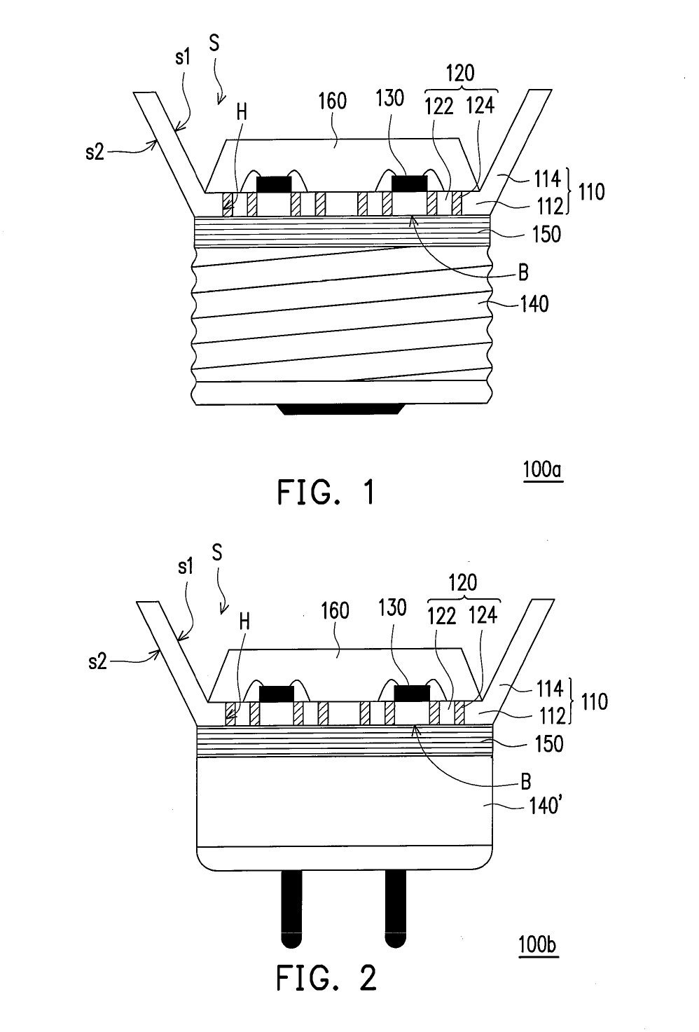

FIG. 1 is a schematic cross-sectional view of an LED lamp according to an embodiment of the present invention. Referring to FIG. 1, an LED lamp 100a mainly includes a substrate 110, a plurality of wire units 120, a plurality of LED chips 130, a lamp cap 140, and a control circuit module 150. Each element of the LED lamp 100a and the connection relation between the elements are described below with reference to the accompanying drawings.

The substrate 110 has an inner surface s1, an outer surface s2, and a bottom part B. The substrate 110 has a carrying portion 112 and a ring frame 114 connected to a periphery of the carrying portion 112, and the carrying portion 112 and the ring frame 114 are formed into a bowl-shaped structure. The carrying portion 112 has a plurality of openings H, and the ring frame forms an accommodating space S on the carrying portion. In an embodiment of the present invention, the substrate 110 is made of a metal material, and the metal material is selected from a group consisting of copper, copper alloy, aluminum, aluminum alloy, composite material formed by copper or copper alloy, and composite material formed by aluminum or aluminum alloy, so as to enhance the heat dissipation efficiency of the substrate 110.

The plurality of wire units 120 is respectively disposed in the openings H. Each wire unit 120 has a wire 122 and an insulating material 124 covering a periphery of the wire 122, such that the wire 122 is electrically isolated from the substrate 110. In an embodiment of the present invention, the insulating material 124 may be a polymer material, glass, ceramic, composite material formed by the above material, or other suitable insulating materials. The plurality of LED chips 130 is disposed on the carrying portion 112 of the substrate 110, and electrically connected to the corresponding wires 122. As shown in FIG. 1, the LED chip 130 is electrically connected to the corresponding wires 122 through a wire bonding technique. However, the LED chip 130 may also be electrically connected to the corresponding wires 122 through a flip-chip bonding technique or other manners, which is not limited in the present invention.

The lamp cap 140 is disposed on the bottom part B of the substrate 110, and has two power contacts (not shown). In this embodiment, the lamp cap 140 is a screw-in lamp cap. However, referring to FIG. 2, a bayonet lamp cap 140′ may also be adopted as the lamp cap of the LED lamp 100b. The type of the lamp cap 140 is not limited in the present invention. Referring to FIG. 1, the control circuit module 150 is disposed between the substrate 110 and the lamp cap 140, and electrically connected to the wire 122 and the two power contacts of the lamp cap 140, so as to control the operations of the LED chips 130. Generally, the control circuit module 150 is a single-layer or multilayer circuit board.

In addition, as shown in FIG. 1, a molding compound 160 may be selectively disposed within the substrate 110, so as to protect the LED chip 130, the wire 122, and the bonding wire connected there-between from being damaged or affected by moistures.

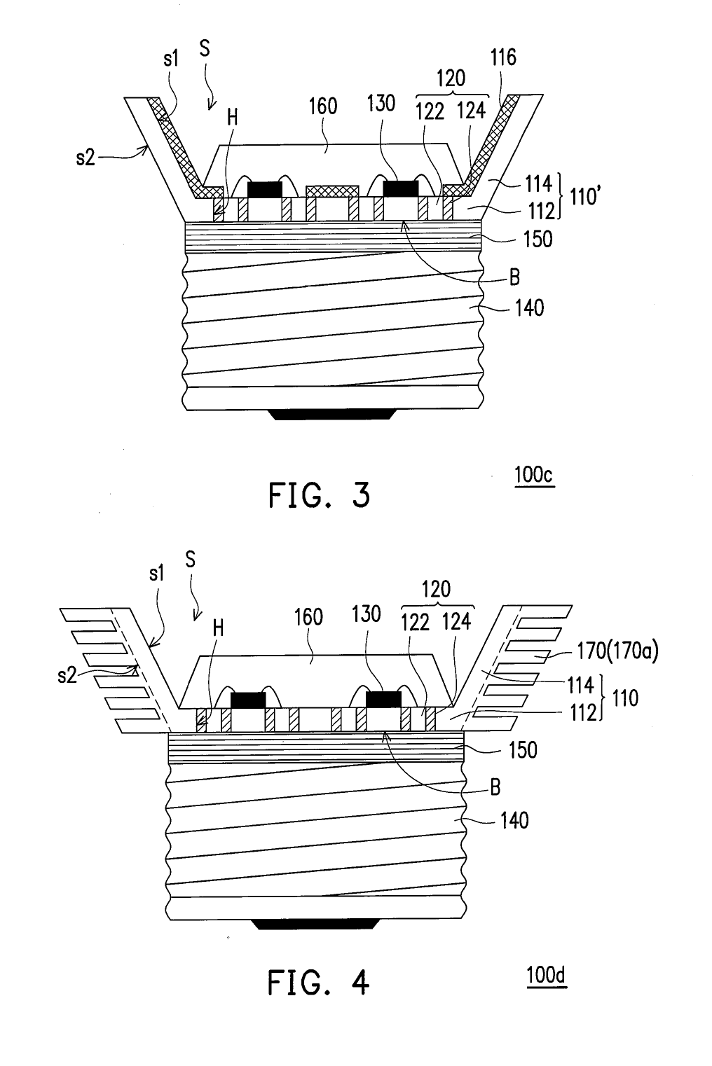

In order to improve the optical reflectivity of the LED lamp, referring to FIG. 3, a substrate 110′ of an LED lamp 100c may further include an optical reflection film 116 disposed on an inner surface s1 of the substrate 100′, thereby reflecting the light rays generated by the LED chips 130 through the optical reflection film 116, so as to increase the light emitting efficiency. In an embodiment of the present invention, the material of the optical reflection film 116 is selected from a group consisting of silver, aluminum, stainless steel, and nickel.

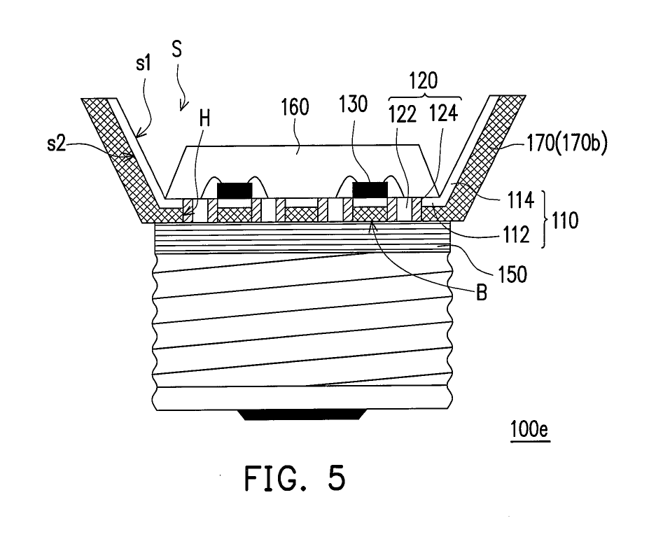

In addition, in order to improve the heat dissipation efficiency of the substrate, referring to FIG. 4, an LED lamp 100d may selectively include a heat sink element 170 disposed on an outer surface s2 of the substrate 110, so as to accelerate the dissipation of the heat energy. In this embodiment, the heat sink element 170 is a plurality of heat sink fins 170a, thereby enlarging the heat dissipation area through the heat sink fins 170a. However, as shown in FIG. 5, the LED lamp 100e may also use a heat pipe 170b as the heat sink element 170. The user may also use the combination of the heat pipe and the heat sink fins as the heat sink element 170, and the type of the heat sink element 170 is not limited in the present invention.

To sum up, in the LED lamp of the present invention, the LED chips are directly packaged on the substrate with the heat dissipation function, so as to dissipate the heats generated during the operation of the LED chips by the substrate with a bowl-shaped structure towards the side edge of the carrying portion or the front edge of the lamp, thereby enhancing the heat dissipation efficiency. In addition, by means of directly packaging the LED chips on the substrate, the interface thermal resistance generated due to the package interface on the heat dissipation path is effectively reduced, and therefore the current heat dissipation problem in configuring the LED lamp may be resolved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A light emitting diode (LED) lamp, comprising:
a substrate, comprising an inner surface, an outer surface opposite to the inner surface, and a bottom part, wherein the substrate comprises a carrying portion and a ring frame connected to the periphery of the carrying portion, and the carrying portion has a plurality of openings;
a plurality of wire units, respectively disposed in the openings, wherein each wire unit comprises a wire and an insulating material covering the periphery of the wire;
a plurality of LED chips, disposed on the carrying portion of the substrate, wherein each LED chip is electrically connected to the corresponding wires;
a lamp cap, disposed on the bottom part of the substrate and provided with two power contacts; and
a control circuit module, disposed between the substrate and the lamp cap, and electrically connected to the wires and the two power contacts.

2. The LED lamp according to claim 1, wherein the substrate is made of a metal material.

3. The LED lamp according to claim 2, wherein the metal material is select from a group consisting of copper, copper alloy, aluminum, aluminum alloy, composite material formed by copper or copper alloy, and composite material formed by aluminum or aluminum alloy.

4. The LED lamp according to claim 1, wherein the substrate further comprises an optical reflection film, disposed on the inner surface of the substrate.

5. The LED lamp according to claim 4, wherein a material of the optical reflection film is selected from a group consisting of silver, aluminum, stainless steel, and nickel.

6. The LED lamp according to claim 1, wherein the insulating material is selected from a group consisting of polymer material, glass, and ceramic.

7. The LED lamp according to claim 1, wherein the LED chips are electrically connected to the corresponding wires through a wire bonding technique.

8. The LED lamp according to claim 1, wherein the LED chips are electrically connected to the corresponding wires through a flip-chip bonding technique.

9. The LED lamp according to claim 1, wherein the lamp cap is a screw-in lamp cap.

10. The LED lamp according to claim 1, wherein the lamp cap is a bayonet lamp cap.

11. The LED lamp according to claim 1, further comprising a heat sink element, disposed on the outer surface of the substrate.

12. The LED lamp according to claim 11, wherein the heat sink element is selected from a group consisting of a plurality of heat sink fins and a heat pipe.

13. The LED lamp according to claim 1, further comprising a molding compound, disposed within the substrate and covering the LED chips.
